(19) United States
(12) Patent Application Publication
(10) Pub. No.: US 2013/0259115 A1
(43) Pub. Date: Oct. 3, 2013

(54) PLURAL PIPELINE PROCESSING TO ACCOUNT FOR CHANNEL CHANGE

(71) Applicant: STMICROELECTRONICS R&D LTD, Marlow (GB)

(72) Inventor: Peter Stieglitz, Wootton Bassett (GB)

(73) Assignee: STMICROELECTRONICS R&D LTD, Marlow (GB)

(21) Appl. No.: 13/845,299

(22) Filed: Mar. 18, 2013

(30) Foreign Application Priority Data
Mar. 28, 2012 (GB) 1205479.7

(51) Int. Cl. H04N 7/26

(52) U.S. Cl. CPC H04N 19/00478
USPC 375/240.01

(57) ABSTRACT

An audio/video processing device includes a first pipeline and a second pipeline. The first pipeline is configured to receive a first program stream and decode the first program stream. The second pipeline is configured to receive a second program stream and at least partially decode the second program stream. In response to selection of the first program stream, the first pipeline is further configured to output the decoded first program stream and the second pipeline is further configured to discard the partially decoded second program stream. In response to selection of the second program stream, the second pipeline is configured to fully decode the second program stream and output the decoded second program stream.

### PRIORITY CLAIM

This application claims priority from Great Britain Application for Patent No. 1205479.7 filed Mar. 28, 2012, the disclosure of which is hereby incorporated by reference.

### TECHNICAL FIELD

The present invention relates to decoding packet streams and particularly but not exclusively to changing between packet streams.

### BACKGROUND

Digital television receivers receive audio and video data in the form of packet streams. Program identifiers (PID) in the packet headers may identify a program stream to which the packet belongs. A receiver may carry out basic signal processing at a front-end and then provide the received transport streams to a demultiplexer which identifies packets belonging to a single program stream in accordance with a program identifier of a program or channel being watched. The demultiplexed packets are then buffered before being transferred to video and audio rendering equipment which provides audio and video to a user.

The encoding of some video information may be such that several packets need to be received and buffered before an image can be reconstructed from information. For example, some video decoding may require information in a preceding frame to decode an image and thus the preceding frame is required so that an image can be reconstructed.

When a new channel or program is selected by a user, a latency due to this buffering and decoding of the received stream may occur.

### SUMMARY

According to a first aspect, there is provided an apparatus comprising: a first pipeline for receiving a first program stream and decoding the first program stream; and a second pipeline for receiving a second program stream and partially decoding the second program stream; wherein when the first program stream is selected, the first pipeline is configured to provide the decoded first program stream to be output and the second pipeline is configured to discard the partially decoded second program stream.

When the second program stream is selected, the second pipeline may be configured to decode the second program stream and provide the decoded second program stream to be output.

The second pipeline may be configured to partially decode the second program stream in accordance with a partial processing mode. The partial processing mode may be one of: a first mode comprising identifying packets of the second program stream before discarding the identified packets; a second mode comprising performing frame analysis on the identified packets before discarding the identified packets; a third mode comprising identifying and decoding reference frames of the identified packets before discarding the reference frames; and a fourth mode comprising identifying and decoding remaining frames of the identified packets before discarding the remaining frames.

The first pipeline may be configured to identify and decode reference frames and remaining frames of identified packets of the first program stream before providing the decoded first program stream to be output.

The second pipeline may be configured to buffer the partially decoded second program stream before discarding it. The apparatus may further comprise a ring buffer for buffering the partially decoded second program stream.

The first program stream may be output to be rendered. The first pipeline may be a decoding pipeline. The decoded first program stream may comprise an audio stream and a video stream. The audio stream may comprise audio frames and the video stream comprises video frames.

According to a second aspect, there is provided an apparatus configured to decode packets from a first program stream, wherein the apparatus operated in accordance with at least one of: a first mode comprising buffering and discarding identified packets of the first program stream; a second mode comprising performing frame analysis on the identified packets before discarding the identified packets; a third mode comprising identifying and decoding reference frames of the identified packets before discarding the reference frames; and a fourth mode comprising identifying and decoding remaining frames of the identified packets before discarding the remaining frames.

According to a third aspect, there is provided a method comprising: receiving and decoding a first program stream; and receiving and partially decoding a second program stream; wherein when the first program stream is selected, the method further comprises: providing the decoded first program stream to be output; and discarding the partially decoded second program stream.

When the second program stream is selected, the method may further comprise: decoding the second program stream; and providing the decoded second program stream to be output.

The second program stream may be partially decoded in accordance with a partial processing mode. The partial processing mode may be one of: a first mode comprising identifying packets of the second program stream before discarding the identified packets; a second mode comprising performing frame analysis on the identified packets before discarding the identified packets; a third mode comprising identifying and decoding reference frames of the identified packets before discarding the reference frames; and a fourth mode comprising identifying and decoding remaining frames of the identified packets before discarding the remaining frames.

Decoding the first program stream may comprise: identifying and decoding reference frames and remaining frames of identified packets of the first program stream before providing the decoded first program stream to be output.

The method may further comprise: buffering the partially decoded second program stream before discarding it.

Providing the first program stream to be output may further comprise providing the first program stream to be rendered.

According to a fourth aspect, there is provided an apparatus comprising at least one processor and at least one memory including computer code for one or more programs, the at least one memory and the computer code configured, with the at least one processor, to cause the apparatus at least to: receive and decode a first program stream; and receive and partially decode a second program stream; wherein when the first program stream is selected, the computer code further causes the apparatus to: provide the decoded first program stream to be output; and discard the partially decoded second program stream.

### BRIEF DESCRIPTION OF THE DRAWINGS

For a better understanding of some embodiments, reference will now be made by way of example only to the accompanying figures in which:

FIG. 1 shows a playback pipeline;

FIG. 2 shows a partial pipeline in accordance with the first embodiment;

FIG. 3 shows a method of decoding a transport stream in accordance with the first embodiment;

FIG. 4 shows multiple pipelines in accordance with the first embodiment;

FIG. 5 shows a method diagram in accordance with the first embodiment;

FIG. 6 shows a partial pipeline in accordance with a second embodiment;

FIG. 7 shows multiple pipelines in accordance with the second embodiment; and

FIG. 8 shows method steps in accordance with the second embodiment.

### DETAILED DESCRIPTION OF THE DRAWINGS

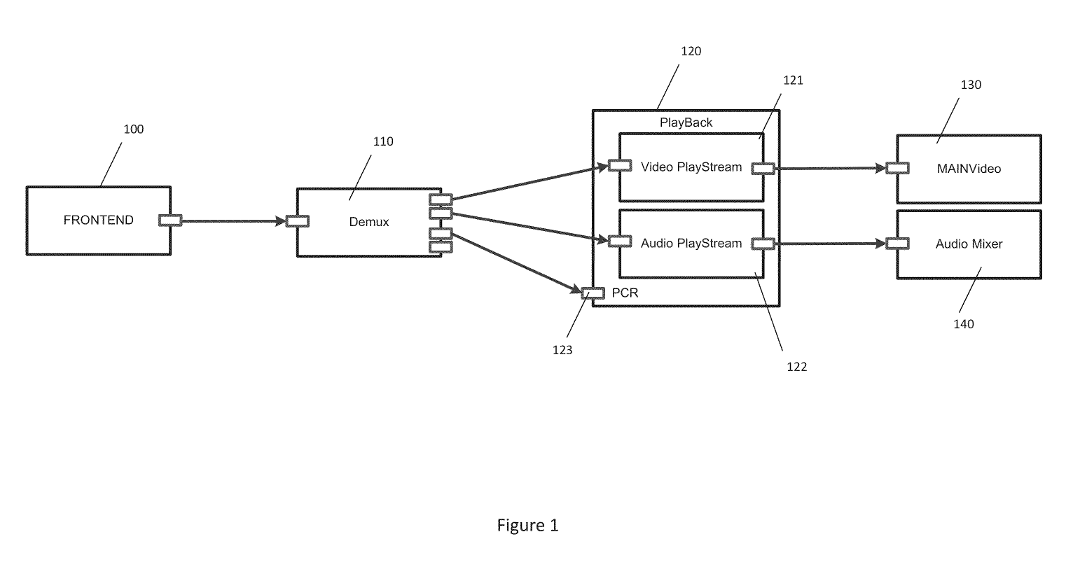

FIG. 1 shows an example of a live broadcast playback pipeline. The playback pipeline of FIG. 1 comprises a front-end 100, a demultiplexer 110, a streaming engine 120, a video renderer 130 and an audio renderer 140. The streaming engine 120 further comprises a video stream 121, an audio stream 122 and optionally a program clock reference (PCR) input 123.

In the pipeline of FIG. 1, the front-end 100 may be tuned to receive transport streams. It will be appreciated that the front-end 100 may be any circuitry capable of being tuned to a transmission carrier frequency, down converting and/or filtering. The received transport stream may then be input to the demultiplexer 110. The demultiplexer 110 may identify and output a single program transport stream corresponding to a program identifier PID. In some embodiments, the demultiplexer may separate packets belonging to a single program transport stream into video, audio and control data packets.

The audio, video and control data packets may be passed to the streaming engine 120. The streaming engine 120 may use the video data to provide a video stream 121. The audio data packets may be used to provide an audio stream 122. In some embodiments, the control data may be a program clock reference PCR and provided to a PCR input 123. It will however be appreciated that the control data packets may not be sent to the streaming engine 120 and may be intercepted and/or processed elsewhere.

The streaming engine may decode and synchronize the audio and video packets. In some embodiments, the streaming engine may provide an audio data speed based on the program clock reference PCR.

The respective video and audio data streams may then be provided to the video and audio renderers 130 and 140 to be rendered for output through audio and video output means. The video and audio streams may be provided as audio and video frames for display.

When a user wishes to change a channel, the program identifier PID used by the demultiplexer 110 is updated to reflect the change of channel or program and identify the new channel or program to be watched. The pipeline stops processing audio and video information and any buffers containing video and audio data corresponding to the old PID are flushed. In some systems, the new program information (identified by the new PID) may be on a different carrier frequency compared to old program information and the front-end may be re-tuned.

Once the front-end starts receiving the transport stream corresponding to the new PID, the demultiplexer identifies a single program transport stream corresponding to the new PID and provides these audio, video and control packets to the streaming engine 120. The streaming engine decodes and synchronizes the new audio and video packets and provides the audio and video streams 121 and 122 to the audio and video renderers 140 and 130.

In order to carry out video and audio processing and decoding, a certain amount of buffered information may be required. This may be for example due to the video decoding for a frame being dependent on information carried in a preceding frame. Therefore in some cases, the audio and video output may only start once the required amount of information has been received.

The time taken in such a channel changeover, from changing the channel to the display of the new channel information can be governed by one or more of the following:
Time to stop audio visual processing
Time to flush buffers
Time to retune the front end (if necessary)
Time to refill the buffers (required for decoding)
Time taken in processing the audio visual information before the audio visual information can be rendered

The time taken to change channels may be for example of the order of one to two seconds. It will be appreciated however that the amount of time taken to change channel in the above manner will differ according to the system used.

Some embodiments provide a system and method for reducing the amount of time needed to change channels.

Some embodiments may cache audio and video data relating to channels not currently being watched. When such a cached channel is selected, the cached audio and video data may be available and may reduce channel change time.

A channel may be cached by setting up a configured pre-tuned data-processing path or pipeline. When a channel is changed, a cached data path may be reassigned as the output data path. This may reduce a time overhead associated with the changing of the channels.

In some embodiments a playback pipeline may be provided to provide audio and video information for a channel being played. Additionally one or more partial pipelines may be provided in which data for additional channels may be cached. These channels may be channels that a user is likely to change too.

A cached channel or partial pipeline may be similar to the playback pipeline, but have reduced processing capability. For example, in a cached channel, packets of a transport stream may be partially processed and buffered before they are discarded as they are not needed to provide video and audio information to the user. However, when a user changes channels to a second channel, the partially processed cached packets of the second channel may be available to be processed further. In this manner partly processed data may be available for the second channel as soon as it is selected.

Two example schemes for providing a cached channel will be described with respect to a first and a second embodiment. While the first and second embodiments are described separately, it will be appreciated that this is for clarity purposes only and that aspects of the first and second embodiments may be combined.

In the first scheme for each partial pipeline, a received transport stream may be demultiplexed and provided in packet form to a decode part. The decode part may carry out a partial decoding of the packets in accordance with a mode of operation. In some embodiments, the decode part may be a streaming engine. In this embodiment, a decode part may be provided for each partial pipeline. In some embodiments, the decode part for each pipeline may operate in a partial mode of operation when the pipeline is not selected for output, and operate in a full mode of operation when that pipeline is selected for output.

In the second scheme, each partial pipeline may be provided with a demultiplexer for identifying and providing a single program transport stream SPTS in accordance with a PID to a buffer. The buffer may buffer the SPTS and discard the packets when the partial pipeline is not selected for output and provide the packets for decoding when the partial pipeline is selected for output.

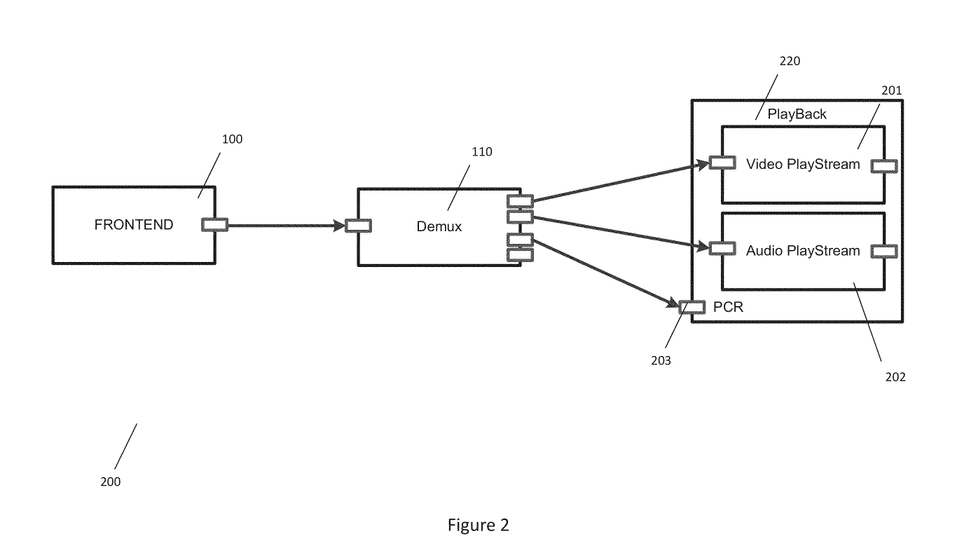

Embodiments in accordance with the first scheme will be described in more detail with relation to FIGS. 2, 3 and 4.

FIG. 2 shows a partial pipeline for caching a channel in accordance with a first embodiment. The partial pipeline of FIG. 2 comprises a front-end 100 providing an input to a demultiplexer 110. The demultiplexer 110 provides an input to a decode part 220 having a video stream 201, an audio stream 202 and a program clock reference input 203.

It will be appreciated that one or more partial pipelines in accordance with the partial pipeline 200 of FIG. 2 may be implemented in addition to the playback pipeline of FIG. 1. The front end 100 may be shared circuitry with the front end 100 of FIG. 1 or may be implemented as a separate front-end. Similarly the multiplexer 110 and decode part 220, while having separate functionality, may share at least some circuitry with the demultiplexer 110 and streaming engine of FIG. 1 in some embodiments.

The demultiplexer 110 may have outputs to provide audio, video and control information to the decode part 220.

In operation, the front-end 100 may receive transmissions carrying video and audio information. The front-end 100 may be tuned to a specific carrier frequency and may provide down converting and other processing in line with the reception of this signal.

Similarly to the demultiplexer of FIG. 1, the demultiplexer 110 of FIG. 2 may identify a single program transport stream SPTS according to a program identifier PID. The program identifier may correspond to a program or channel to be received by the partial pipeline 200.

The demultiplexer 110 may output the identified audio packets, video packets and program clock references to the decode part 220. In some embodiments these packets may be in the form of a packetized elementary stream PES. The program clock reference PCR may be provided to input 203. As discussed with reference to FIG. 1, the PCR may be used in the synchronization of the audio to the video information.

The decode part 220 of the partial pipeline 200 may partially process the received audio and video packets in accordance with a mode of operation. The partially processed packets may be buffered and then discarded if the partial pipeline 200 is not selected for output. The partial pipeline 200 does not provide an audio or video stream to the audio and video renderers 130 and 140 when the channel corresponding to the PID of the partial pipeline 200 is not selected. Instead the partial pipeline 200 caches a partially processed single program transport stream.

Table 1 shows an example of the modes in accordance with which the decode part 220 of the partial pipeline 200 may process the received audio and video data packets. It will be appreciated that in some embodiments one or more of these modes may be implemented individually or in any combination. Other or additional modes may be implemented individually, in combination or in addition to the below modes.

TABLE 1

| Mode | Description |
|---|---|
| PES caching | Buffer *unparsed* PES data early in the play_stream |
| | processing. Since the PES data is unparsed we don't |
| | know its timing properties so we have to know (or |
| | estimate) the size, in bytes, of the largest GOP. |
| ES caching | Buffer *parsed* ES data after frame analysis but |
| | before decode. |
| Reference | Similar to ES caching but unconditionally decode |
| frame decoding | reference frames to simplify (and accelerate) the |
| with partial | transition to full bandwidth mode. Unlike the other |
| ES caching. | approaches this will cost some decoder bandwidth. |
| | Can be used as a development step towards “ES |
| | caching”. |
| Full decode | Full bandwidth mode. Configured to fully decode but |
| and coarse sync | discard frames - Likely to be used as a development |
| | step |

In accordance with a first mode, the partial pipeline 200 and decode part 220 carries out partial processing in accordance with packetized elementary stream PES caching. In this mode, a packetized elementary stream PES data may be cached by buffers in the decode part 220. The data packets received from the demultiplexer 110 may be buffered directly, or minor processing may be carried out on the packets.

In accordance with a second mode, the partial pipeline 200 may cache data in accordance with elementary stream ES data. In this example, the decode part 220 may receive PES packets from the demultiplexer 110 and unpack them into elementary streams. Frame analysis may have further been carried out by the decode part 220. After the frame analysis has been carried out, the elementary streams may be buffered in anticipation of the channel of the partial pipeline being selected.

In accordance with the third mode, further processing may be carried out on the elementary streams of the second mode. In this example in accordance with reference frame decoding with partial ES caching mode, the elementary stream data may have reference frames unconditionally decoded. Having unconditionally decoded reference frames may simplify the transition to a full bandwidth (or playback) pipeline, however this mode may also increase the resources required by the decoding part 220.

In accordance with a fourth mode, the partial pipeline might operate in accordance with the full decode and coarse synchronization mode. In this example the decode part 220 may provide full decoding on the packets received from the demultiplexer 110 to provide a video and audio stream. When this channel is not selected, the video stream the audio stream are buffered and then discarded. In this mode there may be a quick changeover from one channel to another as video stream and audio streams are already available from the decode part.

A trade-off may be found in the use of the system resources and the amount of time taken to change a channel for a system by adjusting the mode used in the partial processing.

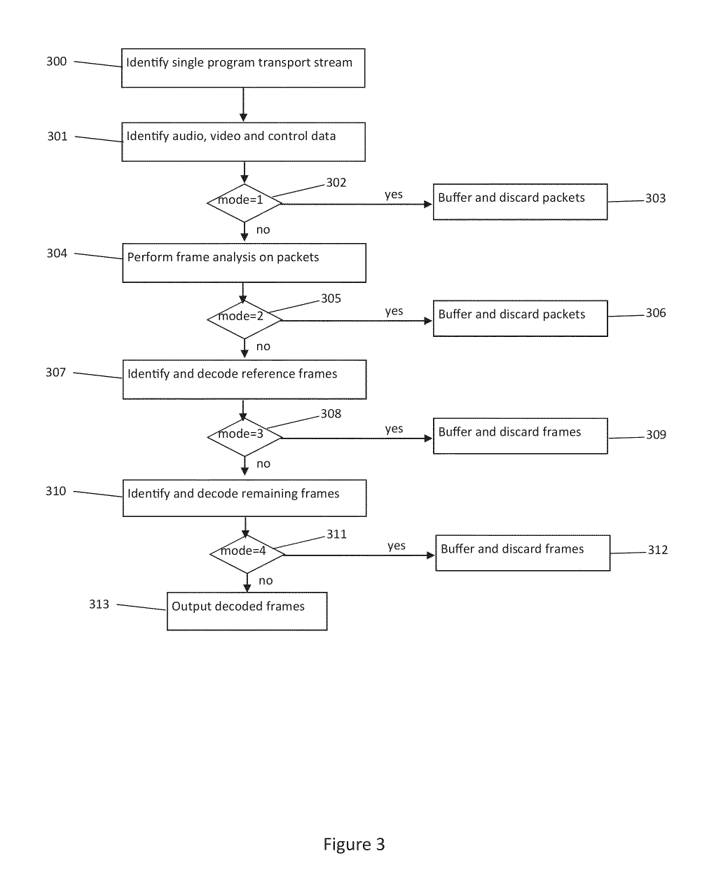

FIG. 3 shows an example of the method steps carried out by a pipeline or partial pipeline. The pipeline may be similar to the pipeline of FIG. 1 and the partial pipeline of FIG. 2.

The pipeline may operate in accordance with a mode of operation, for example one of the modes of operation shown in Table 1. Table 1 shows four exemplary modes with the PES caching being a first mode, ES caching being a second mode, the reference frame decoding with partial ES caching being a third mode, and full decode and coarse sync being a fourth mode.

It will be appreciated that while the example of FIG. 3 shows a pipeline or partial pipeline operating in accordance with one of these four modes, the pipeline may operate in accordance with more, less or different modes to that shown in Table 1.

Steps 300, 301, 304, 307, 310 and 313 of FIG. 3 show exemplary steps taken to decode a packet to form a frame to be output to audio and video renderers. It will be appreciated that these steps are by way of example only and other or additional decode steps may take place in the decoding of the packet.

In the example of FIG. 3, a single program transport stream is identified at step 300. At step 301, audio, visual and control data is identified. In some embodiments, steps 300 and 301 may be carried out by a demultiplexer such as the demultiplexer 110 of FIG. 1 and FIG. 2. Once the relevant audio, visual and control data for a program have been identified, a decode part of the pipeline may carry out frame analysis on the received packets at step 304.

After the analysis, the decode part may further identify and decode reference frames at step 307. In some embodiments, the reference frames may contain information used to decode surrounding and/or related frames. Once the reference frames are decoded, the decode part may identify and decode the remaining frames at step 310. The decode part may also start outputting decoded frames at step 313. For example, the decoded frames may be provided for audio or video rendering.

When the pipeline is operating as playback pipeline (for example, a program identifier of the pipeline corresponds to a program being displayed to a user) the pipeline carries out the steps 300, 301, 304, 307, 310 and 313. However, when the pipeline is being used to cache a channel, for example as the partial pipeline of FIG. 2, only partial processing will take place and only some of the steps 300, 301, 304, 307, 310 and 313 will be carried out.

FIG. 3 shows examples of the partial processing that may take place. After the audio, video and control data packets have been identified at step 301, it is determined whether the pipeline is operating in first mode at step 302. If the pipeline is operating with partial processing in accordance with the first mode, the packets may be buffered and discarded at step 303. However, if the pipeline is not operating in the first mode, the pipeline further performs frame analysis in step 304.

Once the frame analysis has been carried out on the packets, the method proceeds to step 305 and it is determined if the pipeline is operating in accordance with the second mode. If the pipeline is operating in accordance with the second mode, the packets are buffered and discarded at step 306. If the pipeline is not operating in accordance with the second mode, the method continues processing at step 307 where it identifies and decodes reference frames.

The method then proceeds to step 308 where it is determined if the pipeline is carrying out partial processing in accordance with the third mode. If the pipeline is operating in accordance with the third mode, the method proceeds to step 309 where the frames are buffered and discarded. If the pipeline is not operating in accordance with the third mode, the method proceeds to step 310 where the remaining frames identified and decoded.

The method then proceeds to step 311 where it is determined if the pipeline is operating in accordance with the fourth mode. If the pipeline is operating in accordance with the fourth mode, the method proceeds to step 312 where the frames are buffered and then discarded.

If the pipeline is not operating in accordance with fourth mode and is operating as a playback pipeline, the method proceeds to step 313 and the decoded frames are output.

The selection of the first, second, third or fourth mode determines the level of partial processing, or partial decoding, carried out on the packets. If the pipeline is selected as the full playback pipeline, in other words program identifier corresponding to the program selected by a user is held by the pipeline, the pipeline will carry out all of the decoding steps necessary to provide audio and video streams to the audio and video renderers. A full playback pipeline will additionally provide the audio and video streams to the audio and video renderers such that the information can be displayed to the user.

It will be appreciated that the decode parts of each partial pipeline may operate in any of the above modes in some embodiments and may operate in a mode according to a mode selection. The decode parts may additionally be able to operate in a full processing mode and may for example operate in such a mode when a respective partial pipeline is chosen to be the playback pipeline (a channel corresponding to a PID of that partial pipeline is chosen).

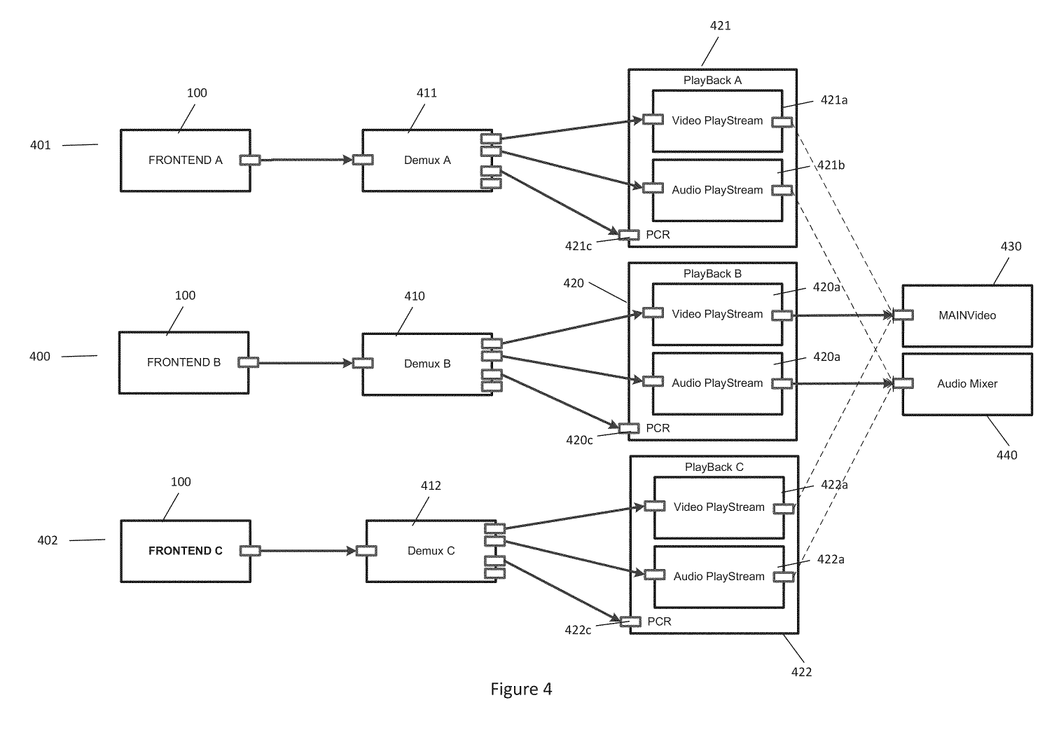

FIG. 4 shows a plurality of pipelines of a decoder comprising a playback pipeline 400, a first partial pipeline 401 and a second partial pipeline 402.

The playback (or selected) pipeline 400 comprises a front-end 100, demultiplexer 100 and decoding part 420. The decoding part 420 comprises a video stream 420a, an audio stream 420b and a PCR input. The video stream 420a is provided to a video renderer 430 and the audio stream 420b is provided to an audio renderer 440. The video and audio renderers 430 and 440 provide rendering of video and audio frames.

The first partial pipeline 401 comprises a front end 100 and a demultiplexer 411. The demultiplexer provides identified video and audio packets and a PCR to a decode part 421. The decode part 421 comprises a video stream 421a, an audio stream 421b and a PCR input 421c. Similarly, the second partial pipeline 402 comprises a front end 100 and a demultiplexer 412. The demultiplexer 412 provides identified video and audio packets and a PCR to a decode part 422. The decode part 422 comprises a video stream 422a, an audio stream 422b and a PCR input 422c.

In operation, the respective front-ends 100 may receive a transport stream and provide the transport stream to a respective demultiplexer 411, 410, 412. The demultiplexers 410, 411, 412 identify the relevant video and audio packets belonging to a single program transport stream in accordance with their PIDs and provide these packets to the decode parts 420, 421 and 422.

The decode parts 421 and 422 of the first and second partial pipelines 401 and 402 carry out partial decoding in accordance with their mode of operation. The partially decoded audio and video information is then buffered and discarded if that partial pipeline is not selected.

The decode part 420 of the playback pipeline 400, carries out a full decoding on the received audio and video packets and provides audio and video frames to the video and audio renderers 430 and 440.

Program information for the channels corresponding to the PIDs of the partial pipelines is cached by the partial pipelines in anticipation of either of those channels being selected by a user.

The program identifies PIDs for the first and second partial pipeline 401 and 402 may be selected as being adjacent to a currently watched channel, as corresponding to most watched channels, or according to other analysis.

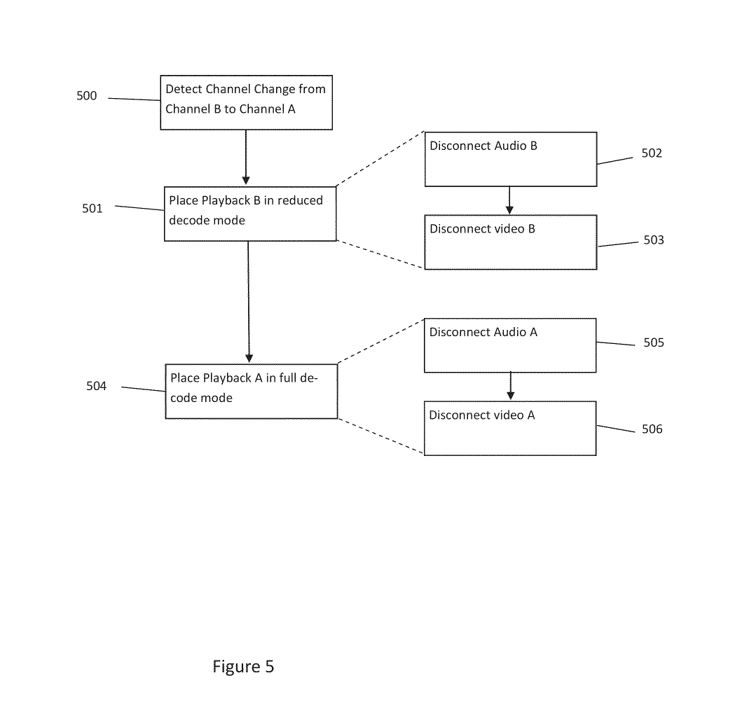

FIG. 5 indicates the method steps when a change of channel occurs in a system such as that shown in FIG. 4.

At step 500, it is determined that a displayed channel has been changed from a first channel B to a second channel A. The first channel B may correspond to the playback pipeline 400 and the second channel B may correspond to the first partial pipeline 401 of FIG. 4.

The playback pipeline 400 of FIG. 4 is placed in a reduced decode mode at step 501 to become a partial pipeline 400. The pipeline 400 may be placed in a reduced decode mode by providing only partial decoding by the decode part 420. This partial decoding may be in accordance with one of the partial decoding modes of Table 1.

The video stream 420a and audio stream the 420b may also be disconnected from the video and audio renderers 430 and 440 at steps 502 and 503. Steps 500, 501, 502 and 503 disconnect the pipeline 400 from the display and convert the playback pipeline 400 to a partial pipeline 400.

The first partial pipeline 401 may then be placed in a playback mode at step 504, converting the partial pipeline 401 to a playback pipeline 401. The pipeline 401 may be made a playback channel by carrying out full processing by the decode part 421. This may be done by putting the decode part in full processing mode.

The video stream 421a and the audio stream 421b from the decode part 421 of the first pipeline 400 may be provided to the video and audio renderers 430 and 440. The channel associated with the pipeline 401 may be output.

When the pipeline 401 is placed in playback mode at step 504, the data buffered by pipeline 401 may be provided to the audio and video renderers 430 and 440, and they may immediately start rendering the audio and video data based on the buffered data.

It will be appreciated that the time taken to change channels will depend on the partial processing mode of the partial pipelines. However it will be appreciated that at least some of the audio and video information is available at the channel change time.

It will further be appreciated that the method steps of FIG. 5 may be carried out in a different order or maybe carried out simultaneously.

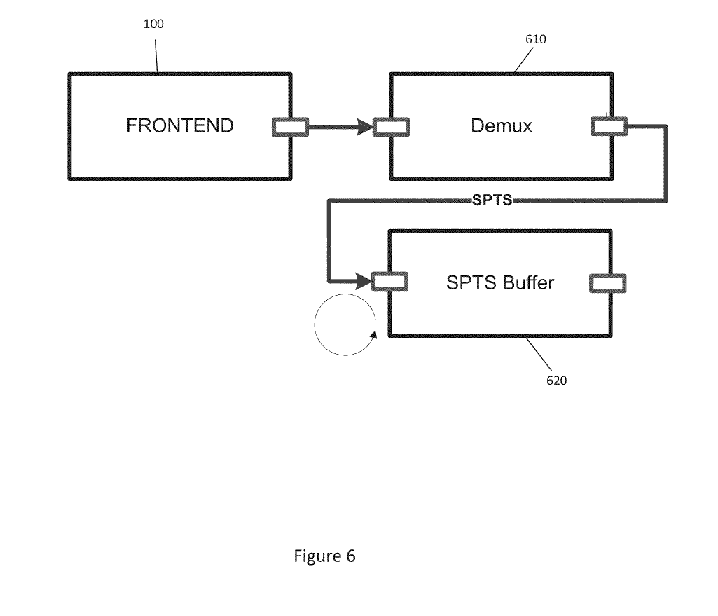

FIG. 6 shows a partial pipeline in accordance with a second embodiment.

FIG. 6 includes a frontend 100, a demultiplexer 610 and a single program transport stream SPTS buffer 620. It will be appreciated that the frontend 100 may be similar to the front ends described above. Similarly the demultiplexer 620 of FIG. 5 may operate similarly to those of FIGS. 1, 2 and 4 however may supply a SPTS as a single stream instead of breaking the stream up into audio, video and/or control information.

In the partial pipeline 600, the demultiplexer 610 may identifies a single program transport stream SPTS based on a program identifier. The single program transport stream SPTS may buffer packets received from the demultiplexer 610. In some embodiments the buffer 620 is a circular buffer. When the buffer is full, the oldest packets are overwritten so that the buffer contains the most recent packets received from the demultiplexer 620. It will however be appreciated that this is by way of example only and the buffer 620 may be any suitable buffer.

In accordance with this embodiment, program data is cached by the single program transport stream buffer 620 at the output of the demultiplexer 610, rather than being partially processed by a decode part of the first embodiment.

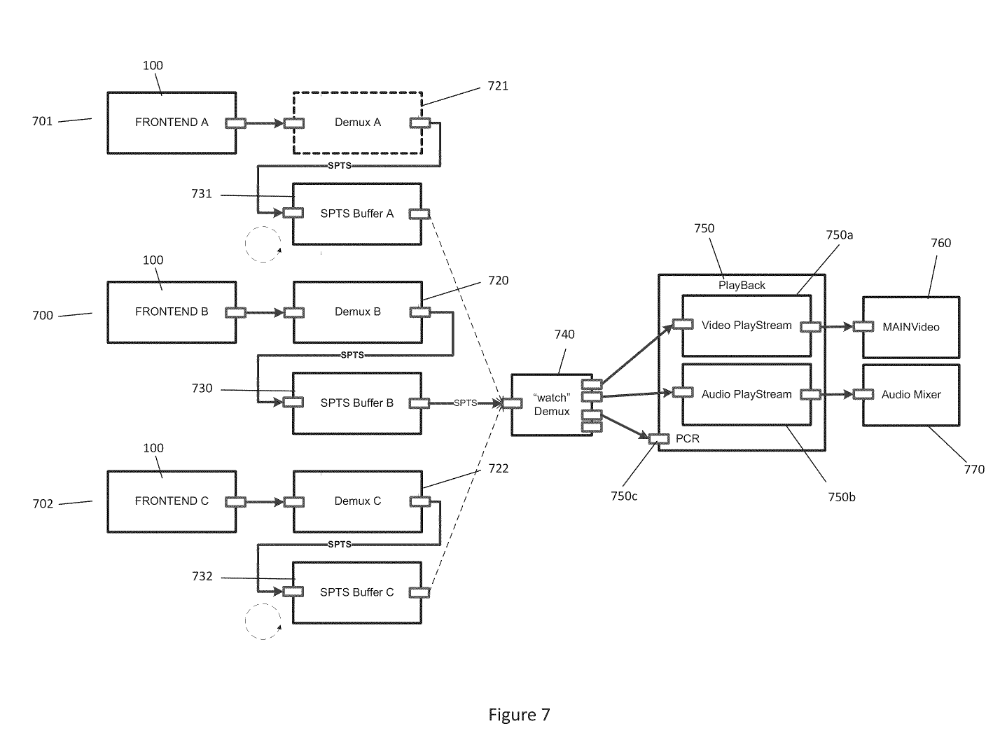

FIG. 7 shows a decoder having a playback pipeline 700 and a first and second partial pipeline 701 and 702 in accordance with a second embodiment.

The playback pipeline 700 comprises a frontend 100, demultiplexer 720 and a single program transport stream buffer SPTS 730. The output of the SPTS 730 is input into a “watch” demultiplexer 740. The “watch demultiplexer 740 identified audio, video and control packets in the stream and provides these to a streaming engine. The “watch” demultiplexer demultiplexes the audio, video and control information for a program currently being watched.

The streaming engine 750 has a video stream 750a, an audio stream 750b and a program clock reference input 750c and receives the audio, video and control information from the “watch” demultiplexer 740. The streaming engine 750 carries out processing to generate audio and video streams which are provided to the video and audio renderers 760 and 770 to be rendered for display.

The first partial channel 701 comprises a frontend 100, a demultiplexer 721 and a SPTS buffer 731. Similarly, the second partial pipeline 702 comprises a frontend 100, a demultiplexer 722 and a SPTS 732.

While packets from the SPTS buffer 730 of the watched channel's pipeline are provided to the “watch” demultiplexer 740, the packets from the SPTS buffers 731 and 732 are buffered and then discarded until they the channel corresponding to that pipeline is selected.

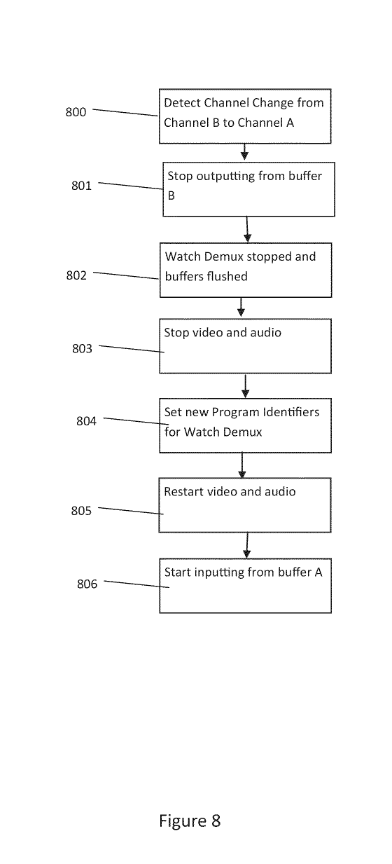

The method carried out when a channel has changed in accordance with the decoder of FIG. 7 is depicted by the method steps of FIG. 8.

At step 800 a channel is change from a first channel corresponding to the playback pipeline 700 to a second channel corresponding to the pipeline 701.

When the channel change is detected, at step 801, the single program transport stream SPTS packets of the first pipeline 700 cease to be output by SPTS buffer 730.

The “watch” demultiplexer 740 also stops outputting packets to the streaming engine 750 and the buffers of the demultiplexer 740 are flushed.

Audio and video processing and rendering carried out by the streaming engine 750 and the renderers 760 and 770 is stopped at step 803. Additionally buffers of the streaming engine 750 may also be flushed in some embodiments.

The “watch” demultiplexer may be set with a new program identifier PID corresponding to the program identifier associated with the second channel. In some embodiments this may be done by setting a register in the “watch” demultiplexer 740.

The audio and video processing by the streaming engine 750 and audio and video rendering may be restarted and the output of the SPTS buffer 731 of pipeline 704 is provided to the input of the “watch” demultiplexer 740 in step 806.

With the “watch” demultiplexer 740 using the program identifier identifying the single program transport stream from the first pipeline 701, video, audio and program clock reference information is provided to the streaming engine 750. The streaming engine 750 processes the packets from the pipeline 701 and provides the resultant audio and video streams to the audio and video renderers 770 and 760.

It will be appreciated that when the output of the single program transport stream buffer 730 from the pipeline 700 is disconnected from the “watch” demultiplexer 740, pipeline 700 becomes a partial pipeline as it is no longer connected to output. When the output of the SPTS buffer 731 of the first pipeline 701 is connected to the “watch” demultiplexer 740, the first pipeline 701 becomes the playback pipeline as it is now connected to the video and audio renderers 760 and 770 as well as the streaming engine 750.

It will further be appreciated that the method steps in FIG. 8 may be executed in a different order and some method steps may be executed simultaneously.

Further embodiments of the invention may include power management. For example the power management may determine a mode of partial decoding for a partial pipeline. For example, in accordance with the first embodiment, the mode for the partial processing may be selected in accordance with the power requirements of the system. Additionally or alternatively, partial pipelines may be disabled in order to conserve power at the cost of a slower channel change.

It will be appreciated that the first embodiment may additionally implement single program transport stream STS buffers and may include mode that operates in accordance with the second embodiment.

For example, the mode of operation of the partial pipelines may be set in accordance with a time since a digital display or channel has been changed. For example, if the digital display has been recently changed, it can be considered that there is higher chance of a channel being changed and the partial pipeline processing mode may be set as such. Alternatively, if it has been a long time since the digital display has been changed, it can be considered that there is not a high chance of the channel being changed and the partial pipelines may be shut down or be put in a mode where they conserve power.

While this detailed description has set forth some embodiments of the present invention, the appended claims cover other embodiments of the present invention which differ from the described embodiments according to various modifications and improvements. For example, embodiment may be carried out by an application running on an apparatus having a processor and memory. In some embodiments, a multiplicity of resources may be available to an application (for example, the number of tuners or frontends and demultiplexers). The application may determine: how these resources should be allocated to implement the channel change; the channel caching model: whether the “back” button channel, channels either side of the current playing channel or another heuristic technique is use is an application design decision and not in the scope of this document. The resources may be allocated such that the best user experience is obtained. For broadcast descrambling, section data may be to be processed and control keys set. Each scrambled cached channel may be implemented.

In some embodiments, a pipeline may decode more than one single program transport stream, for example, single program transport streams relating to services associated with a channel decoded by the pipeline. The pipeline may identify the streams with a program identifier common to the streams associated with a channel or may have program identifiers corresponding to each of the streams. For example, in some embodiments a single program transport stream may be provided for audio data and for video data. In embodiments, a pipeline may receive and identify packets associated with a television channel that may be watched by a user. In some embodiments, a program identifier of a packet may identify it as belonging to a service provided by a single transport stream. It will also be appreciated that while three pipelines have been describes in examples, more or less pipelines may be provided. For example, a playback pipeline may be provided along with one or more partial pipelines.

Some embodiments may be applicable to IP set top boxes wanting to implement the channel change. A single IP frontend may be analogous to RF frontend that produces a single program transport stream SPTS. In some embodiments, ancillary data may be the responsibility of the application to manage the ancillary data path for example, the management of sub-titles.

Active and passive power management modes may be implemented in some embodiments, having the effect of disabling the complete decode pipelines. Some embodiments may implement timeout: if the display has not been changed for specified period the cached pipelines would move to a power conservation mode (frontends, demuxes and decodes). The decoder may back propagate the state after the timeout. When the display is moved the pipelines may be resumed. A MEMS device in the remote control may be used to indicate the users possible intention of a channel change in some embodiment, for example it can been determined that while a channel is watched the remote control is likely to be at rest.

It will be appreciated that the features of the figures may be implemented in circuitry and or by a digital processor in software. It may also be appreciated that while three pipelines have been depicted, more or less may be implemented in some embodiments. It will also be appreciated that some of the circuitry may be shared between pipelines. For example, a frontend or demultiplexer may be shared between pipelines. Alternatively or additionally, the functional features of some pipelines may be provided in software and by a digital signal processor.

It will be appreciated that the pipelines may be implemented in an apparatus or as part of a collection of apparatuses. The pipelines may form part of a decoder, for example a digital signal decoder. The digital signal decoder may decoder digital video, audio and/or multimedia signals. In some embodiments, the pipelines may be implemented in software and provided by a processor and associated memory, or may form a mix of software and hardware components. In some embodiments the processor may be a digital signal processor.

Some aspects of the embodiments may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The apparatus may for example form part of a set top box, as part of a personal computer, for example as a TV reception card, as part of a mobile device, tablet or any receiver having a processor and one or more memories. Some embodiments may be implemented by computer software executable by a data processor of the mobile device, such as in the processor entity, or by hardware, or by a combination of software and hardware.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

What is claimed is:

1. An apparatus, comprising:
a first pipeline configured to receive a first program stream and decode the first program stream; and
a second pipeline configured to receive a second program stream and partially decode the second program stream;
wherein in response to selection of the first program stream, the first pipeline is further configured to output the decoded first program stream and the second pipeline is configured to discard the partially decoded second program stream.

2. The apparatus of claim 1, wherein in response to selection of the second program stream, the second pipeline is configured to fully decode the second program stream and output the decoded second program stream.

3. The apparatus of claim 1, wherein the second pipeline is configured to partially decode the second program stream in accordance with a partial processing mode.

4. The apparatus of claim 3, wherein the partial processing mode is one of:
a first mode configured to identify packets of the second program stream before discarding the identified packets;
a second mode configured to perform frame analysis on the identified packets before discarding the identified packets;
a third mode configured to identify and decode reference frames of the identified packets before discarding the reference frames; and
a fourth mode configured to identify and decode remaining frames of the identified packets before discarding the remaining frames.

5. The apparatus of claim 4, wherein the first pipeline is configured to identify and decode reference frames and remaining frames of identified packets of the first program stream before providing the decoded first program stream to be output.

6. The apparatus of claim 4, wherein the second pipeline is configured to buffer the partially decoded second program stream before discarding.

7. The apparatus of claim 1, further comprising a ring buffer configured to buffer the partially decoded second program stream.

8. The apparatus of claim 1, wherein the first program stream is output to be rendered.

9. The apparatus of claim 1, wherein the first pipeline is a decoding pipeline.

10. The apparatus of claim 1, wherein the decoded first program stream comprises an audio stream and a video stream.

11. The apparatus of claim 9, where the audio stream comprises audio frames and the video stream comprises video frames.

12. An apparatus configured to decode packets from a first program stream, wherein the apparatus operated in accordance with at least one of:
a first mode configured to buffer and discard identified packets of the first program stream;
a second mode configured to perform frame analysis on the identified packets before discarding the identified packets;
a third mode configured to identify and decode reference frames of the identified packets before discarding the reference frames; and
a fourth mode configured to identify and decode remaining frames of the identified packets before discarding the remaining frames.

13. A method, comprising:
receiving and decoding a first program stream; and
receiving and partially decoding a second program stream;
wherein in response to selection of the first program stream, the method further comprises:
outputting the decoded first program stream; and
discarding the partially decoded second program stream.

14. The method of claim 13, wherein in response to selection of the second program stream, the method further comprises:
decoding the second program stream; and
output the decoded second program stream.

15. The method of claim 13, wherein partially decoding the second program stream comprises performing a partial processing mode.

16. The method of claim 15, wherein the partial processing mode is one of:
a first mode configured to identify packets of the second program stream before discarding the identified packets;
a second mode configured to perform frame analysis on the identified packets before discarding the identified packets;
a third mode configured to identify and decode reference frames of the identified packets before discarding the reference frames; and
a fourth mode configured to identify and decode remaining frames of the identified packets before discarding the remaining frames.

17. The method of claim 16, wherein decoding the first program stream comprises:
identifying and decoding reference frames and remaining frames of identified packets of the first program stream before providing the decoded first program stream to be output.

18. The method of claim 13, further comprising: buffering the partially decoded second program stream before discarding.

19. The method of claim 13, wherein outputting the first program stream further comprises rendering the first program stream.

20. An apparatus comprising at least one processor and at least one memory including computer code for one or more programs, the at least one memory and the computer code configured, with the at least one processor, to cause the apparatus at least to:
receive and decode a first program stream; and
receive and partially decode a second program stream;
wherein in respect to selection of the first program stream, the computer code further causes the apparatus to:
output the decoded first program stream; and
discard the partially decoded second program stream.
